(19) United States
(12) Patent Application Publication
(10) Pub. No.: US 2004/0208393 A1
(43) Pub. Date: Oct. 21, 2004

(54) Image processing device, image processing method, and image processing program product for making determination based on spectrum

(75) Inventor: Toshio Nakakuki, Mizuho-Shi (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/823,898

(22) Filed: Apr. 14, 2004

(30) Foreign Application Priority Data
Apr. 17, 2003 (JP) 2003-113145

(51) Int. Cl. G06K 9/40; G06K 9/00

(52) U.S. Cl. 382/274; 382/172

(57) ABSTRACT

An image processing device is provided comprising an image acquisition unit for acquiring image data to be processed, and an image processing unit for extracting a spectrum of a predetermined physical quantity in the image data, and making a determination as to whether or not the spectrum has a plurality of peaks, wherein a process is performed based on a result of the determination.

### CROSS-REFERENCE TO RELATED APPLICATIONS

The priority application Number JP2003-113145 upon which this patent application is based is hereby incorporated by reference.

### BACKGROUND OF THE INVENTION

1. Field of the Invention

The present invention relates to image processing devices, image processing methods, and image processing program products used for image correction. More particularly, the present invention relates to an image processing device, an image processing method, and an image processing program product for performing image correction on image data captured under backlighting conditions.

2. Description of the Related Art

When a photograph is taken with a very bright background, i.e. under backlighting conditions, with cameras (image capturing devices) using photoelectric transducers, charge coupled devices (CCD), or the like, image data with a darkened object is acquired. In such image data captured under backlighting conditions, the object cannot be clearly pictured, and therefore backlight correction for adjusting luminance in the image data is desired.

Generally in image data of a person with a landscape background, a relatively bright portion, such as the sky, tends to be captured in an upper portion of the image data, and a relatively dark portion, such as a road, tends to be captured in a lower portion thereof.

By way of example, Japanese Patent Laid-Open Publication No. Hei 8-18850 discloses that, based on such a tendency of luminance arrangement in image data, upper and lower portions of image data are detected, and a determination can be made that the image data has been captured under backlighting conditions when the luminance in the upper portion of the image data exceeds a predetermined threshold. In this publication, backlight correction is performed based on such a determination by, for example, decreasing the luminance in the upper portion of the image data, which tends to be a high value, and adjusting the aperture of the camera to increase exposure when a photograph is taken.

When a photograph is taken with a camera, a user tilts it vertically and horizontally. As a result, in order to perform backlight correction based on the relationship in vertical positions of the image data acquired by taking a photograph, a detection sensor for detecting a rotation angle of the camera, and a control circuit therefor must be provided to detect the upper portion of the acquired image data.

However, incorporation of the detection sensor and its peripheral circuits into a camera increases the size of the camera itself, leading to higher manufacturing costs. When the detection sensor and the like are not incorporated for the sake of reduced manufacturing costs of the camera, backlight correction cannot be achieved.

### SUMMARY OF THE INVENTION

The present invention according to one aspect provides an image processing device for acquiring image data to be processed, extracting a spectrum of a predetermined physical quantity in the image data, making a determination as to whether or not the spectrum has a plurality of peaks, and performing a process based on a result of the determination.

According to another aspect, the present invention provides an image processing method for acquiring image data to be processed, extracting a spectrum of a predetermined physical quantity in the image data, making a determination as to whether or not the spectrum has a plurality of peaks, and performing a process based on a result of the determination.

According to a further aspect, the present invention provides an image processing program product for causing a computer to acquire image data to be processed, extract a spectrum of a predetermined physical quantity in the image data, make a determination as to whether or not the spectrum has a plurality of peaks, and perform a process based on a result of the determination.

### BRIEF DESCRIPTION OF THE DRAWINGS

FIG. 1 is a block diagram showing a configuration of an image processing device according to an embodiment of the present invention.

FIG. 2 is a flowchart of an image processing method according to the embodiment of the present invention.

FIG. 3 shows an exemplary luminance spectrum obtained from image data captured under non-backlighting conditions.

FIG. 4 shows an exemplary luminance spectrum obtained from image data captured under backlighting conditions.

FIG. 5 is a view for describing a method of detecting the number of peaks according to the embodiment of the present invention.

### DESCRIPTION OF PREFERRED EMBODIMENTS

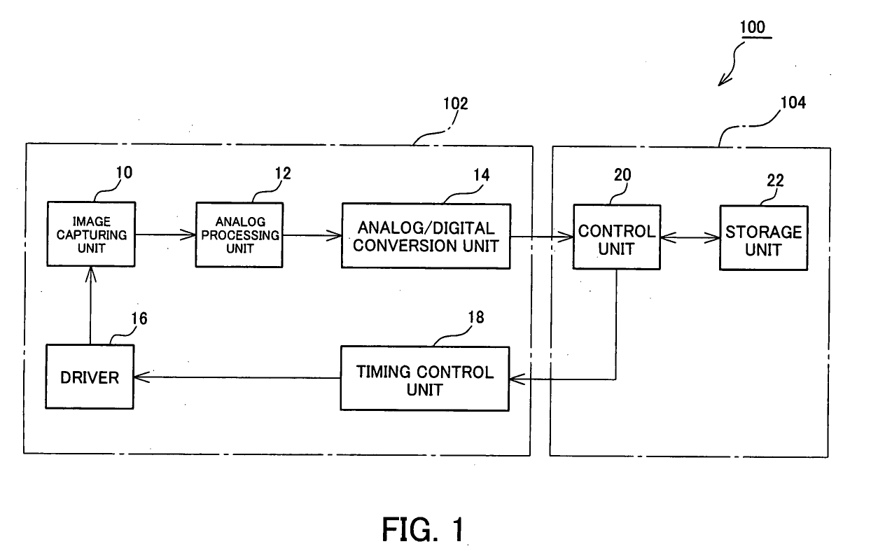

A configuration of an image capturing device according to a preferred embodiment of the present invention will now be described in detail with reference to FIG. 1.

An image capturing device 100 in the present embodiment is roughly divided into an image acquisition unit 102 and an image processing unit 104.

The image acquisition unit 102 basically includes an image capturing unit 10, an analog processing unit 12, an analog/digital conversion unit (AD conversion unit) 14, a driver 16, and a timing control unit 18.

The image capturing unit 10 includes components for capturing an image of an object, such as a lens, a shutter, an aperture, and a photoelectric transducer. The image capturing unit 10 receives light from the object, and performs photoelectric conversion to produce image data. The produced image data is supplied to the analog processing unit 12.

While the image data acquired by the image capturing unit 10 is described as two-dimensional color image data in the present embodiment, the present invention is not limited thereto. Image data indicating intensity of each of the three primary colors, i.e. red (R), green (G), and blue (B), may be acquired by the image capturing unit 10 to obtain color image data. The image data may be commonly used two-dimensional data, or one-dimensional image data acquired by an array of CCDs arranged in columns. The image data may also be monochrome.

The analog processing unit 12 performs an analog process on the received image data. The process performed here is not particularly limited, and processes such as filtering can be performed. The analog-processed image data is supplied to the AD conversion unit 14.

The AD conversion unit 14 quantizes the received image data into small image elements (pixels). By way of example, for color image data, the image data corresponding to red (R), green (G), and blue (B), may be divided into a group of pixels in a matrix, and the luminance for each pixel may be represented as 8-bit data. In this case, the luminance of each pixel in the image data is converted into a numerical value on a scale of 0-255. When the image data is monochromatic, it may be divided into a group of pixels in a matrix, and the brightness of each pixel may be represented as 8-bit data. Through AD conversion, the image data is turned into digitized image data that can be handled by a computer. The digitized image data is supplied to the image processing unit 104.

The timing control unit 18 receives a determination result supplied from a control unit 20 of the image processing unit 104, and provides a control signal related to shutter timing and the aperture in the image capturing unit 10 based on the determination result. The driver 16 receives the control signal from the timing control unit 18, and drives the image capturing unit 10. The process performed in the image processing unit 104 will be described later.

Although the image acquisition unit 102 of the present embodiment described above is constructed as a digital still camera, the present invention is not limited thereto. The image acquisition unit 102 may be any device capable of acquiring image data, such as a video camera acquiring a moving image, and a scanner or a copy machine for reading image data from printed media.

The image processing unit 104 is basically composed of the control unit 20 and a storage unit 22, which are connected via a bus to exchange information each other.

The control unit 20 includes a central processing unit (CPU) running an image processing program prestored and held in the storage unit 22 to perform image processing. The storage unit 22 is formed of a storage device, such as a semiconductor memory. The storage unit 22 stores and holds the image processing program executed by the control unit 20, the image data supplied from the AD conversion unit 14, an intermediate result of the process performed in the image processing unit 104, and the like. It is also preferable to use a supplementary mass storage medium for the storage unit 22, such as a hard disk, an optical disk, and a magneto-optical disk, when a large volume of data must be handled for storing a plurality of image data items and the like. The information held in the storage unit 22 can be referred to by the control unit 20 upon necessity.

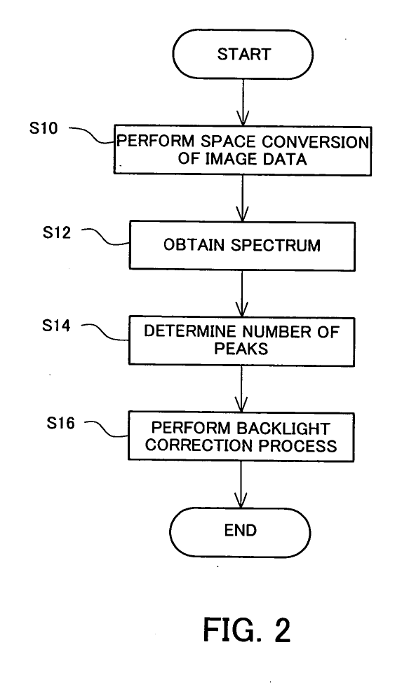

The process performed for running the image processing program will now be described. FIG. 2 is a flowchart of the image processing according to the present embodiment. The image processing program is obtained by converting each step in the flowchart of FIG. 2 into a program executable by the image processing unit 104.

At a step S10, the image data is converted into image data represented in terms of a predetermined physical quantity, such as luminance and color difference. For example, image data represented in the RGB (red, green, blue) color space is converted into image data represented in the YUV color space where Y represents the luminance, U represents the red color difference, and V represents the blue color difference. For color space conversion, existing conversion formulas can be used.

At a step S12, a spectrum of the predetermined physical quantity is obtained for the image data. For example, a luminance spectrum is obtained for the image data represented in terms of luminance (Y). The luminance spectrum is the relationship between a luminance and the number of pixels having that luminance in the image data of the luminance (Y). For example, when the luminance of each pixel is represented in 8 bits from the darkest to the brightest, the luminance spectrum can be obtained as the number of pixels on a scale of 0-255 from the darkest to the brightest. This step S12 corresponds to the spectrum extracting means.

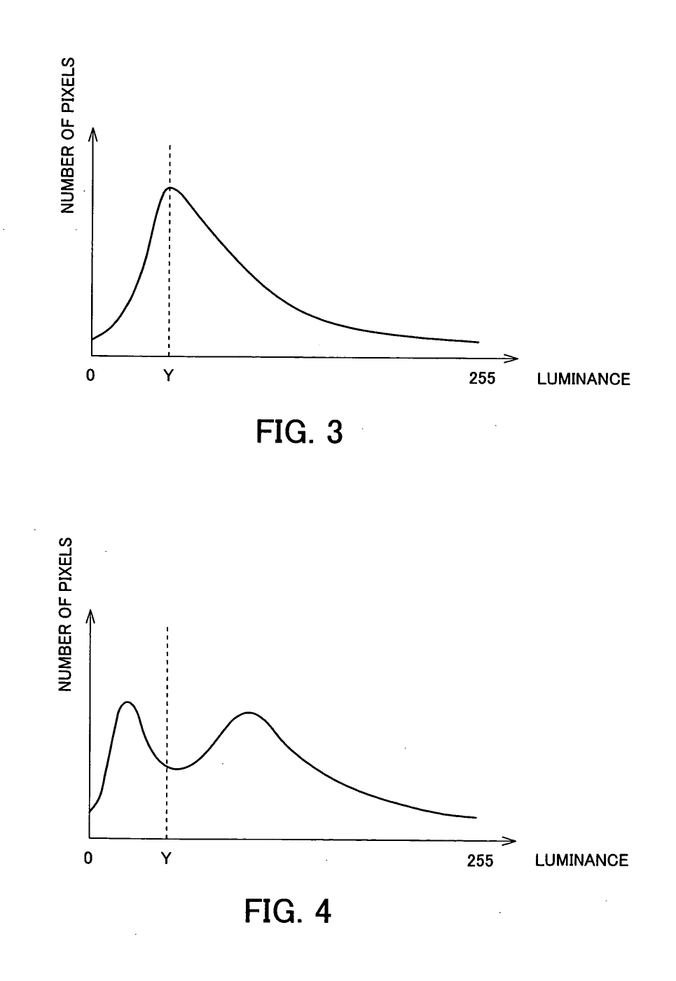

At a step S14, a determination is made as to whether or not the spectrum obtained at the step S12 has a plurality of peaks. As illustrated in FIG. 3, the luminance spectrum has a single gentle peak when the image data is acquired under non-backlighting conditions. On the other hand, when image data is acquired under backlighting conditions, the luminance spectrum generally has two or more significant peaks, as illustrated in FIG. 4. In other words, when it is assumed that the luminance spectrum in average image data acquired under non-backlighting conditions reaches a peak at the luminance Y, peaks in the image data acquired under backlighting conditions generally appear on both sides of the above luminance Y.

A determination as to whether or not the spectrum has a plurality of peaks can be made based on, with respect to the spectrum, an integral value of a range where the predetermined physical quantity is no greater than a first threshold, and an integral value of a range where the predetermined physical quantity is no smaller than a second threshold which is greater than the first threshold. For the determination, at least one of the first and second thresholds is preferably set based on an average level of the predetermined physical quantity.

More specifically, the first threshold is set at an arbitrary value in a range between, and including, 10% and 50% of the average level of the predetermined physical quantity, and the second threshold is set at an arbitrary value not smaller than 130% of the average level of the predetermined physical quantity. The spectrum is preferably determined as having a plurality of peaks when at least two of the following three conditions are satisfied. The first condition is that, with respect to the spectrum, the integral value of the range where the predetermined physical quantity is no greater than the first threshold occupies 10% or more of an integral value of the entire region. The second condition is that the integral value of the range where the predetermined physical quantity is no smaller than the second threshold occupies 15% or more of the integral value of the entire region. The third condition is that the sum of the integral value of the range where the predetermined physical quantity is no greater than the first threshold and the integral value of the range where the predetermined physical quantity is no smaller than the second threshold occupies 30% or more of the integral value of the entire region.

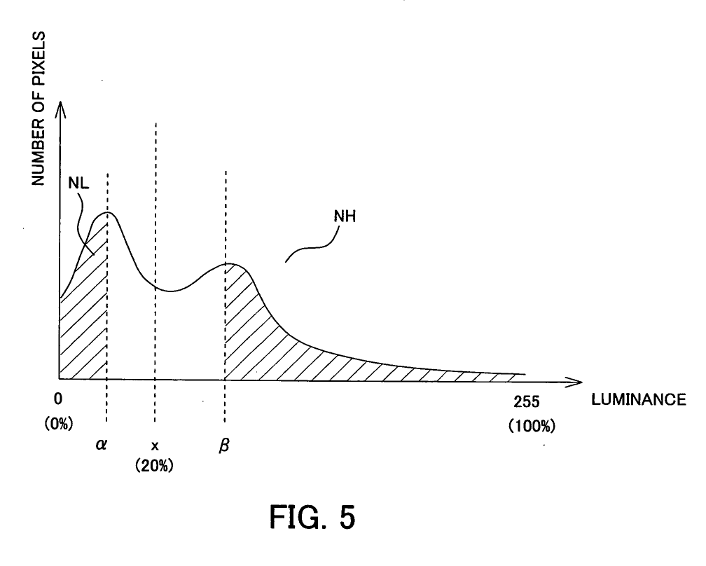

Cameras generally have the automatic exposure function for maintaining the average level of the luminance at a fixed level. When it is assumed that the luminance is expressed as 0-100% and that automatic exposure correction is performed so that the average level X of the luminance in image data is at 20% of the maximum luminance, the spectrum is determined as having two or more peaks by satisfying two of the following three conditions, as illustrated in FIG. 5. The first condition is that the total number of pixels N_{L} in a range between the minimum luminance and a value α (where 0<α<X) is no smaller than a predetermined threshold T_{L1}. The second condition is that the total number of pixels N_{H} in a range between a value β (where X<β<maximum luminance) and the maximum is no smaller than a predetermined threshold T_{H1}. The third condition is that the sum of the values N_{L} and N_{H} is no smaller than a predetermined threshold T_{LH1}.

Preferably, the value a is set at an arbitrary value in a range between, and including, 10% and 50% of the luminance X, the value β at an arbitrary value no smaller than 130% of the luminance X, and the thresholds T_{L1}, T_{H1}, and T_{LH1} at the values no smaller than 10%, 15%, and 30%, respectively, of the total number of pixels in the image data. Preferably, the specific values are adjusted appropriately in the above-mentioned ranges according to the object and the photo-taking conditions.

The values 10%, 15%, and 30% in the above first to third conditions naturally vary depending on how the values α and β are selected. More specifically, such condition values are increased when the selected values α and β are near the average of the predetermined physical quantity (luminance X), and decreased when they are far from the average of the predetermined physical quantity (luminance X).

For example, when the values α and β are selected as 30% and 130%, respectively, of the average of the predetermined physical quantity (luminance X), the first to third condition values are set at 25%, 35%, and 60%, respectively. Meanwhile, when the values α and β are selected as 20% and 180%, respectively, of the average of the predetermined physical quantity (luminance X), the first to third condition values are set at 15%, 20%, and 35%, respectively. Such setting substantially assures detection of image data under backlighting conditions.

The spectrum is preferably determined as having a plurality of peaks when at least two of the following three conditions are satisfied with the value a set at an arbitrary value in a range between, and including, 10% and 50% of the average of the predetermined physical quantity (luminance X), and the value β at an arbitrary value not smaller than 130% of the average of the predetermined physical quantity (luminance X) . With respect to the spectrum, the first condition is that the integral value N_{L} of a range where the luminance is no greater than the value α is in a range between, and including, 10% and 40% of the integral value of the entire range. The second condition is that the integral value N_{H} of a range where the luminance is no smaller than the value β is in a range between, and including, 15% and 40% of the integral value of the entire range. The third condition is that the sum of the values N_{L} and N_{H} of the range where the luminance is no greater than the value α and no smaller than the value β, respectively, is in a range between, and including, 30% and 70% of the integral value of the entire region.

Thus, the thresholds α and β are preferably varied in accordance with the average level X of the predetermined physical quantity (luminance). This is because the average luminance level is varied in accordance with the brightness if the camera does not have the automatic exposure function, and, even with such a function, the average level of the image is varied in accordance with the brightness adjusting function. Accordingly, both of the above thresholds α and β must be changed for each acquired image.

The above-described method makes it possible to determine with high precision whether or not the spectrum has a plurality of peaks.

It is also preferable to detect the peak position in the spectrum using existing means for detecting the peak position, and to perform the process for the spectrum with two or more peaks when the distance between the peaks is no smaller than a predetermined threshold T_{W}, as illustrated in FIG. 5.

The determination result as to the number of peaks is provided to the timing control unit 18. This step S14 implements determination means in the image processing unit 104 for determining whether or not the spectrum has a plurality of peaks.

At a step S16, a process is performed based on the determination result obtained at the step S14. For example, a signal is supplied to the timing control unit 18 for setting exposure time varied based on the determination result. When the spectrum is determined as having a single peak, a setting signal for assigning normal exposure time is supplied to the timing control unit 18. On the other hand, when the spectrum is determined as having two or more peaks, a setting signal for assigning exposure time longer than usual is supplied to the timing control unit 18. The timing control unit 18 provides the driver 16 with signals for adjusting the aperture and opening/closing timing of the shutter suitable for the received signal of assigning exposure time. Receiving these signals, the driver 16 adjusts the aperture and the shutter timing in the image capturing unit 10.

It is also preferable that a plurality of determination conditions are set at the step S14 to supply a signal for setting exposure time varied in accordance with such determination conditions. By thus setting different exposure time in accordance with the plurality of determination conditions, a finely tuned correction process can be performed corresponding to the backlighting level.

In the above process of varying exposure time, backlight correction is performed only on the image data captured after the image data used for peak number determination is acquired. In this respect, the image data subject to peak number determination at the step S12 may also be processed. By way of example, usual γ correction is preferably performed on the image data when the spectrum is determined as having a single peak, and modulated γ correction is performed on the image data when the spectrum is determined as having two or more peaks. By thus making direct correction on image data, optimum backlight correction can be performed for each image data item.

Thus, the step S16 corresponds to image processing means in the image processing unit 104.

While the peak is detected based on the luminance spectrum of image data in the present embodiment, the spectrum of other physical quantities may be used. The spectrum here means the relationship between the number of pixels and a predetermined physical quantity in the pixels included in image data. For example, the peak may be detected based on the spectrum of hue intensity for red (R) or the like. When the original image data is monochromatic, the spectrum of brightness in image data may be used for peak detection.

It should be noted, however, that the luminance spectrum is preferably used for peak detection because a plurality of peaks corresponding to backlighting clearly appear in the luminance spectrum.

While the process is performed on the image data divided into mesh-like pixels and quantized as digital image data in the present embodiment, alternatively analog image data may be processed as in the following example. The spectrum of a predetermined physical quantity is first obtained. Assuming that the average spectrum level in average image data acquired under non-backlighting conditions is a physical quantity value Z, the spectrum can be determined as having a plurality of peaks when the integral value of the spectrum of a range between the minimum value and γ (0<γ<Z) is no smaller than a threshold T_{L} and the integral value of the range where the physical quantity is λ (Z<λ<maximum physical quantity) is no smaller than a threshold T_{H}.

While the image acquisition unit 102 and the image processing unit 104 are incorporated in the single image capturing device 100 in this embodiment, these units may be provided as separate devices. For example, image data captured with a digital camera corresponding to the image acquisition unit 102 may be stored in a memory card, and the image data may be loaded from the memory card to a computer corresponding to the image processing unit 104 for image processing.

As described above, image data can be corrected without detecting the rotation angle of image data, and this technique is especially effective for backlight correction. The present application is based on Japanese Patent Application No. 2003-113145, and the invention herein can be understood by referring to that application.

What is claimed is:

1. An image processing device for acquiring image data to be processed, extracting a spectrum of a predetermined physical quantity in said image data, making a determination as to whether or not said spectrum has a plurality of peaks, and performing a process based on a result of the determination.

2. The image processing device according to claim 1, wherein said physical quantity is a signal varied in accordance with a change in an amount of light or a luminance.

3. The image processing device according to claim 1, wherein the determination as to whether or not said spectrum has a plurality of peaks is made based on, with respect to said spectrum, an integral value of a range where said physical quantity is no greater than a first threshold, and an integral value of a range where said physical quantity is no smaller than a second threshold which is greater than said first threshold.

4. The image processing device according to claim 3, wherein at least one of said first and second thresholds is set based on an average level of said physical quantity.

5. The image processing device according to claim 2, wherein
said first threshold is smaller than the average level of said physical quantity, and said second threshold is greater than the average level of said physical quantity, and
said spectrum is determined as having a plurality of peaks when satisfying at least two conditions out of:
a first condition that an integral value of a range where said physical quantity is no greater than said first threshold is no smaller than a first percentage of an integral value of the entire range;
a second condition that an integral value of a range where said physical quantity is no smaller than said second threshold is no smaller than a second percentage of the integral value of the entire range; and
a third condition that a sum of the integral value of the range where said physical quantity is no greater than said first threshold and the integral value of the range where said physical quantity is no smaller than said second threshold is no smaller than a third percentage of the integral value of the entire range.

6. An image processing method for acquiring image data to be processed, extracting a spectrum of a predetermined physical quantity in said image data, making a determination as to whether or not said spectrum has a plurality of peaks, and performing a process based on a result of the determination.

7. The image processing method according to claim 6, wherein said physical quantity is a signal varied in accordance with a change in an amount of light or a luminance.

8. The image processing method according to claim 6, wherein the determination as to whether or not said spectrum has a plurality of peaks is made based on, with respect to said spectrum, an integral value of a range where said physical quantity is no greater than a first threshold, and an integral value of a range where said physical quantity is no smaller than a second threshold which is greater than said first threshold.

9. The image processing method according to claim 8, wherein at least one of said first and second thresholds is set based on an average level of said physical quantity.

10. The image processing method according to claim 7, wherein
said first threshold is smaller than the average level of said physical quantity, and said second threshold is greater than the average level of said physical quantity, and
said spectrum is determined as having a plurality of peaks when satisfying at least two conditions out of:
a first condition that an integral value of a range where said physical quantity is no greater than said first threshold is no smaller than a first percentage of an integral value of the entire range;
a second condition that an integral value of a range where said physical quantity is no smaller than said second threshold is no smaller than a second percentage of the integral value of the entire range; and
a third condition that a sum of the integral value of the range where said physical quantity is no greater than said first threshold and the integral value of the range where said physical quantity is no smaller than said second threshold is no smaller than a third percentage of the integral value of the entire range.

11. An image processing program product for causing a computer to acquire image data to be processed, extract a spectrum of a predetermined physical quantity in said image data, make a determination as to whether or not said spectrum has a plurality of peaks, and perform a process based on a result of the determination.
